(19) United States
(12) Patent Application Publication
(10) Pub. No.: US 2025/0174932 A1
(43) Pub. Date: May 29, 2025

(54) ELECTRICAL PLUG AND PROCESSING METHOD THEREOF

(71) Applicant: Yueqing Shenchuang Electric Technology Co., Ltd., Yueqing (CN)

(72) Inventor: Guangqiang WANG, Yueqing (CN)

(73) Assignee: Yueqing Shenchuang Electric Technology Co., Ltd., Yueqing (CN)

(21) Appl. No.: 18/542,418

(22) Filed: Dec. 15, 2023

(30) Foreign Application Priority Data
Nov. 29, 2023 (CN) 202323229561.2

(51) Int. Cl. H01R 13/52; H01R 13/502; H01R 43/18

(52) U.S. Cl. CPC H01R 13/5202; H01R 13/502; H01R 43/18

(57) ABSTRACT

Disclosed are an electrical plug and its processing method, aiming to solve the problem that most existing electrical plugs are mainly enhanced for overall tightness using fasteners, but the sealing effect is still not satisfactory. In this application, after the housing is installed by fastening with bolts, a sealing layer is further added inside the grooves at the connection on its outer side, which further enhances the sealing effect of the plug. Moreover, the sealed surface and the side of the housing are at the same level, making it more aesthetically pleasing and reliable.

### CROSS-REFERENCE TO RELATED APPLICATIONS

This application claims priority to Chinese Patent Application No. 202323229561.2, filed on Nov. 29, 2023, the content of which is incorporated herein by reference in its entirety.

### TECHNICAL FIELD

The present application relates to a plug, specifically to an electrical plug and its processing method.

### BACKGROUND

As disclosed in Chinese Patent CN219917738U, titled “Waterproof Plug for Shielded Pump,” when the plug is fixed, the compression of the spring will make the sealing strip two tightly abut against the outer wall of the socket. In this way, the plug is well sealed by the sealing strip two and the protective housing, and the sealing strip two seals between the plug and the socket panel. The sealing strip fits closely with the outer wall of the plug. The protective housing completely encases the plug, thus achieving the waterproof effect.

However, most existing electrical plugs are still using fasteners to increase the overall tightness, and the sealing effect still needs to be improved.

### SUMMARY

To solve the above problems, the present application proposes an electric plug with a simple structure, good sealing effect, and reliable stability, as well as its processing method.

The electric plug of the present application comprising a terminal and a housing. The housing includes: a first housing with a through hole passing through the terminal, at least one pillar on the back of the first housing, and a connecting groove for accommodating bolts inside the first housing; a second housing with at least two raised elements for clamping the terminal, a threaded groove that matches the connecting groove, and the terminal is installed by passing through the through hole after being clamped on the raised elements; both the first and second housings have grooves on the outer side of the end that connects them, and a sealing layer is filled in the grooves after the first and second housings are assembled; the second housing also has a positioning slot that matches the pillar.

In the present application, the connecting groove and the through hole are concentrically arranged, and the connecting groove has a channel that communicates with the threaded groove. The diameter of the connecting groove is larger than that of the threaded groove, and the diameter of the channel is greater than or equal to the diameter of the threaded groove but smaller than the diameter of the connecting groove.

In the present application, the pillar extends outward, and the positioning slot is surrounded by at least three protrusions. When the first and second housings are assembled, the pillar is inserted into the positioning slot with an interference fit.

In the present application, there are four pillars and the same number of positioning slots.

In the present application, the first housing also has multiple reinforcing ribs on the inner side wall.

In the present application, the back of the second housing has a handle, which is an integral structure with the second housing.

A processing method for the electric plug includes the following steps:
S100, assembling the two housings of the plug with fasteners, and reserving interconnected grooves on the outer surface of the joint of the two housings;
S200, performing secondary reinforcement on the connection between the two housings by sealing the grooves, thereby improving the overall sealing and mechanical strength.

Compared with the prior art, the present application has the following beneficial effects.

After the housing of the present application is installed by bolts and then a sealing layer is added in the grooves on its outer side, the sealing effect of the plug is further strengthened, and the sealing layer and the side of the housing are at the same horizontal height, making it more beautiful and reliable.

In the present application, the first and second housings also have first and second protrusions respectively. Fitting the first protrusion outside the second protrusion, effectively prevents the sealant from penetrating the inside of the housing during sealing, which is very reliable.

### BRIEF DESCRIPTION OF THE DRAWING

To better explain the technical solutions in the embodiments or prior art of the present application, a brief introduction of the drawings required in the embodiments or prior art description will be given below. The drawings described below are only some embodiments of the present application. Ordinarily, skilled technicians in this field can obtain other drawings based on these drawings without creative labor.

FIG. 1 is a schematic diagram of the overall structure of the electrical plug in embodiment 1.

FIG. 2 is a schematic diagram of the internal structure of the housing in embodiment 1.

FIG. 3 is a schematic diagram of the three-dimensional structure of the housing in embodiment 1.

FIG. 4 is a schematic diagram of the production method process in embodiment 2.

### DETAILED DESCRIPTION OF THE EMBODIMENTS

### Embodiment 1

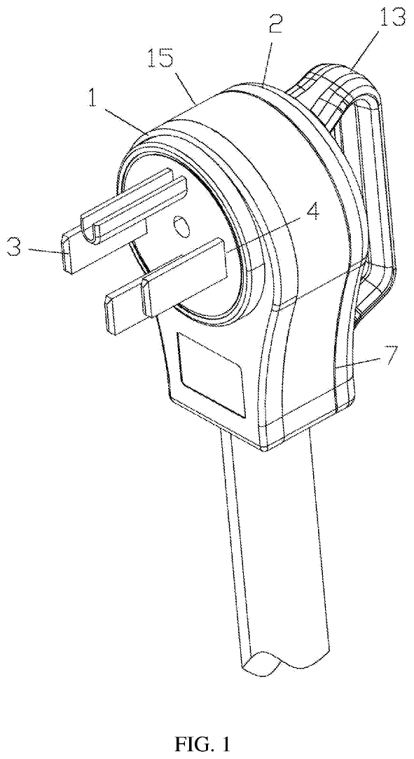

As shown in FIG. 1, the overall structural diagram of the electrical plug is shown. The electrical plug includes a housing and four terminals 3 set in the housing and extending to the outside. The housing includes a first housing 1 and a second housing 2 fitted with it. There are interconnected grooves 7 on the outer surface of the first housing 1 and the second housing 2.

Specifically, two grooves 7 are set at one end where the first housing 1 and the second housing 2 are connected. When the first housing 1 is assembled with the second housing 2, the two grooves 7 together form a complete groove. In this application, a sealing layer 15 is provided in the grooves 7 through the sealing process at the connection of the first housing 1 and the second housing 2, thereby further strengthening the connection strength and sealing effect of the two through the sealing process based on the original assembly by fastening structure.

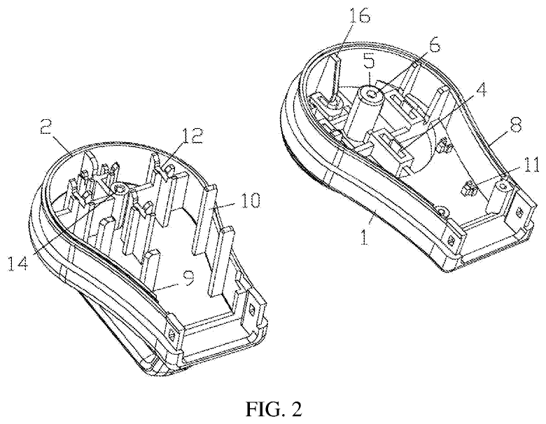

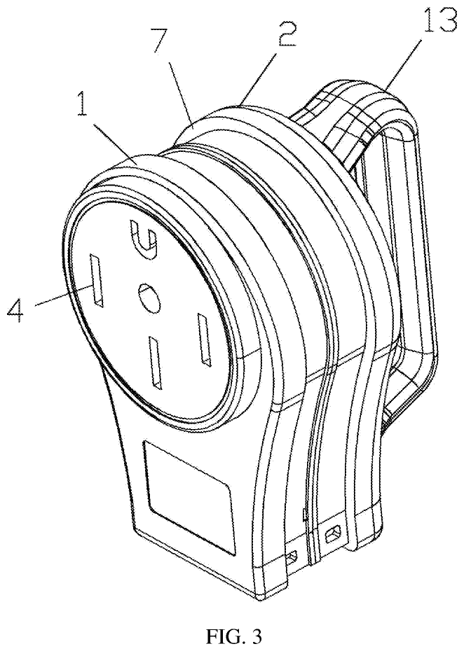

As shown in FIGS. 2-3, the first housing 1 in FIG. 2 is the front side housing, with four through-holes 4 for the terminals 3 to pass through. When the terminals 3 are installed on the second housing 2, they pass through the through-holes 4 for installation. The second housing 2 is the back side housing in FIG. 2, with four raised elements 12 for fixing the terminals 3 by welding, bonding, or press-fitting. The positions and quantities of the raised elements 12 correspond to the positions and quantities of the through-holes 4. The raised elements 12 and the through-holes 4 are located at the upper part of the second housing 2 and the first housing 1, and there are also four vertical pillars 10 at the lower part of the second housing 2.

The pillars 10 are rectangular in structure, and there are four corresponding positioning slots 11 at the lower part of the first housing 1. The positioning slots 11 are surrounded by three compact adjacent protrusions. When in use, the first housing 1 is assembled with the second housing 2, and the end of the pillar 10 is inserted into the positioning slot 11 first, thus positioning the installation through the priority cooperation of the pillar 10 and the positioning slot 11. This improves the installation efficiency of the first housing 1 and the second housing 2.

Furthermore, the first housing 1 and the second housing 2 are also provided with a first protrusion 8 and a second protrusion 9, respectively. The first protrusion 8 is located on the outer side of the connecting end of the first housing 1, and the second protrusion 9 is located on the inner side of the connecting end of the second housing 2. During installation, the first protrusion 8 fits on the outer side of the second protrusion 9 to prevent the sealant from entering the interior of the plug during sealing.

Referring to FIG. 2, there is an inwardly extending connecting groove 5 at the upper part of the first housing 1, and a threaded groove 14 coinciding with the connecting groove 5 is provided at the upper part of the second housing 2. When the first housing 1 is assembled with the second housing 2 (refer to FIG. 3), they are further secured by bolts passing through the through-hole 6 and the threaded groove 14.

Note that the diameter of the through-hole 6 should be equal to or greater than the diameter of the threaded groove 14, but smaller than the diameter of the connecting groove 5, to form a positioning flange and be fastened with the threaded groove 14 and bolts.

Furthermore, multiple reinforcing ribs 16 are provided on the inner wall of the first housing 1 to increase the structural strength. The five reinforcing ribs 16 are evenly distributed on the inner surface of the first housing 1.

In this application, a one-piece handle 13 is also added to the back of the second housing 2, so that users can better pull out or install the plug into the socket using the handle 13.

### Embodiment 2

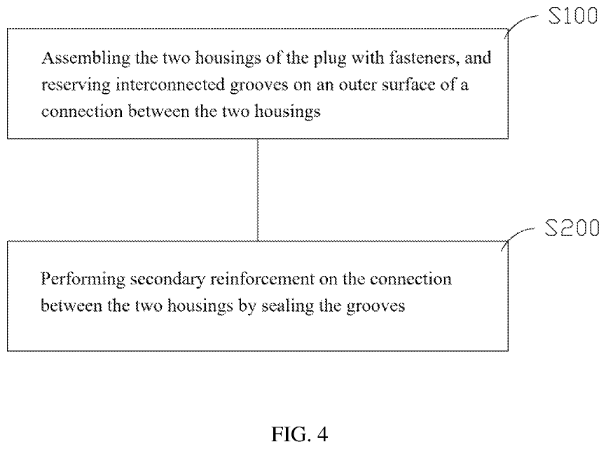

As shown in FIG. 4, the difference from embodiment 1 is that the present application also discloses a processing method for an electrical plug, including S100-S200:

S100, assembling the two housings of the plug with fasteners, and reserving interconnected grooves on the outer surface of the connection between the two housings of the plug;

This step is to assemble the two housings of the plug through the internal fastening structure, which is the installation step of the electrical plug in the prior art.

S200, performing secondary reinforcement on the connection between the two housings by sealing the grooves, thereby improving the overall sealing and mechanical strength.

This step is to further increase the sealing effect and waterproof level of the housings by performing secondary reinforcement on the connection between the two housings with sealant.

The above-described embodiments are only examples of preferred embodiments of the present application, and do not limit the conception and scope of the present application. Various modifications and improvements made by those skilled in the art to the technical solutions of the present application without departing from the design concept of the present application should fall within the protection scope of the present application, and the technical content of the present application to be protected has been fully described in the claims.

What is claimed is:

1. An electrical plug, comprising terminals and a housing,
wherein the housing comprises:
a first housing, with a through-hole for the terminals, at least one pillar on a back of the first housing, and a connecting groove for accommodating bolts inside the first housing; and
a second housing, with at least two raised elements for securing the terminals and threaded grooves that match the connecting groove; wherein the terminals are secured on raised elements and then inserted through the through-hole; both outer walls of one end of the first housing and the second housing have grooves; after the first and second housings are assembled, a layer of sealant is filled in the grooves, and the second housing also has positioning slots that match the pillars.

2. The electrical plug according to claim 1, wherein the connecting groove is concentric with the through-hole, and the connecting groove has a channel that communicates with the threaded groove; a diameter of the connecting groove is larger than the diameter of the threaded groove, and the diameter of the channel is equal to or greater than the diameter of the threaded groove but smaller than the diameter of the connecting groove.

3. The electrical plug according to claim 2, wherein the pillars extend outward, and the positioning grooves are surrounded by at least three protrusions; when the first housing and the second housing are assembled, the pillars are press-fit into the positioning grooves.

4. The electrical plug according to claim 3, wherein there are four pillars, and the number of positioning grooves is the same as the number of pillars.

5. The electrical plug according to claim 4, wherein an inner wall of the first housing also has multiple reinforcing ribs.

6. The electrical plug according to claim 5, wherein a back of the second housing has a handle, and the handle is a one-piece structure with the second housing.

7. A processing method of the electrical plug according to claim 1, comprising the following steps:
S100, assembling the two housings of the plug with fasteners, and reserving interconnected grooves on an outer surface of a connection between the two housings; and
S200, performing secondary reinforcement on the connection between the two housings by sealing the grooves.
